(19) United States
(12) Patent Application Publication
(10) Pub. No.: US 2009/0061395 A1
(43) Pub. Date: Mar. 5, 2009

(54) SEQUENCE DOT CONNECT SHEETS

(75) Inventor: Toni M. Schulken, Charlotte, NC (US)

Correspondence Address: THOMPSON HINE L.L.P.;Intellectual Property Group, P.O. BOX 8801, DAYTON, OH, 45401-8801, US

(73) Assignee: MEAD WESTVACO CORPORATION, Glen Allen, VA (US)

(21) Appl. No.: 11/847,845

(22) Filed: Aug. 30, 2007

(51) Int. Cl. G09B 11/00

(52) U.S. Cl. 434/85

(57) ABSTRACT

A drawing sheet assembly including a drawing sheet and a plurality of dots printed on the sheet. The dots have a differing optical property relative to each other. The drawing sheet assembly further includes a sequence guide configured guide a user to connect the dots in a particular sequence such that when a user connects the plurality of dots in accordance with the sequence guide a drawing or part of a drawing is created.

The present invention is directed to dot connect sheets, more particularly, to dot connect sheets wherein the dots have a different optical property relative to each other.

### BACKGROUND

Preschool children and others learning to draw or write may utilize tools, guides or the like to aid in their development. Such tools, guides or the like may help to develop the user's writing instrument control skills, visual motor control skills, fine motor control skills, visual perception skills and bilateral coordination skills. The development of these skills helps to advance and improve the user's writing and drawing skills.

### SUMMARY

In one embodiment, the invention is a drawing sheet assembly including a drawing sheet and a plurality of dots printed on the sheet. The dots have a differing optical property relative to each other. The drawing sheet assembly further includes a sequence guide configured guide a user to connect the dots in a particular sequence such that when a user connects the plurality of dots in accordance with the sequence guide a drawing or part of a drawing is created.

### BRIEF DESCRIPTION OF THE DRAWINGS

FIG. 1 is a top view of various drawing sheets of one embodiment of the present invention;

FIG. 2 is a top view of a drawing sheet illustrating another embodiment of the invention with the dot pattern being partially completed;

FIG. 3 is a top view of another embodiment of the drawing sheet of the present invention; and

FIG. 4 is a top view of the drawing sheet of FIG. 3 in a completed state.

### DETAILED DESCRIPTION

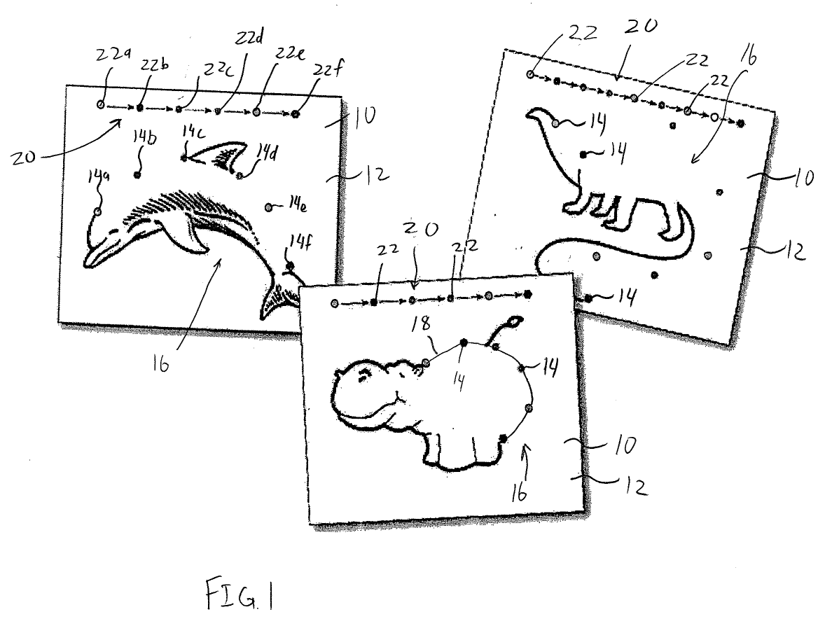

As shown in FIGS. 1-4, the present invention may take the form of a drawing sheet 10 taking the form of or including a sheet of paper 12 with a plurality of dots 14 printed on the sheet. The sheet 10 may include a drawing 16, or a latent or incomplete drawing printed thereon. Alternately, the sheet 10 may be generally blank except for the dots 14.

The sheet of paper 12 can be made from any of a wide variety of materials, but will typically be made of a cellulose-based or pulp-based paper such that the paper 12 is generally water absorbent and can be written upon a wide variety of media (i.e., pens, pencils, markers, crayons etc.) The sheet 12 may be relatively thin, and may have a thickness of about 0.5 mm or less. However, the sheet 12 can be made of any of a relatively wide variety of materials, and need not necessarily be of a water-absorbent material (i.e. could be a write-on/wipe off (polymer) material that can be re-used, etc.)

The plurality of dots 14 may be configured such that when the dots 14 are connected with lines 18 by the user in the proper order or sequence, the lines 18 form a drawing or shape 16, or complete or substantially complete a drawing or shape 16. For example, FIG. 1 illustrates three drawing sheets 10 illustrating a partially-drawn dolphin, a partially-drawn dinosaur and a hippopotamus, respectively. When the dots 14 are connected in their proper sequence, the drawing 16 of the dolphin, dinosaur and hippopotamus are completed.

Each of the dots 14 may have a differing optical property relative to each other (i.e. a visually apparent property besides relative position). For example, in the embodiment of FIG. 1, each dot 14 may have a differing color. With respect to the dolphin drawing of FIG. 1, dot 14a may be blue, dot 14b may be green, dot 14c may be red, dot 14d may be yellow, dot 14e may be orange, and dot 14f may be purple. Each sheet 10 may include a sequence guide 20 printed thereon which instructs, or provides guidance to, a user as to the order of sequence in which the dots 14 should be connected. For example, in FIG. 1, the sequence guide 20 include a plurality of dots or patches or portions of color 22 arranged in a left-to-right sequential order. In the illustrated embodiment, the sequence guide 20 includes arrows extending between each portion 20 to further enforce the sequence order.

In the dolphin drawing of FIG. 1, portion 22a is blue, portion 22b is green, portion 22c is red, portion 22d is yellow, portion 22e is orange and portion 22f is purple. Thus, in this embodiment, the sequence guide 20 instructs a user to connect the dots 14 of the corresponding dolphin drawing in the blue-green-red-yellow-orange-purple order to thereby complete the drawing 16. Thus, the user connects the dots with lines 18 (which can be generally straight, angled or curved) to finish the drawing 16, or, in some cases, create a completely new drawing.

In the embodiment shown in FIG. 1, the color sequence 20 has color portions 22 in a number that corresponds to the number of dots 14 in the drawing 16 (i.e. there is a one-to-one correspondence between the portions 22 and dots 14). In some cases, (i.e. if there are relatively a high number of dots 14 in the drawing 16) the number of portions 22 and dots 14 may not correspond (i.e. the dots 14 may outnumber the portions 22). In this case, the user can understand, or be instructed, that the color sequence guide 20 presents a pattern which can be repeated, as necessary, to complete the drawing 16.

In the illustrated embodiment, each of the dots 14 and color portions 22 are generally circular. However, it should be understood that the dots 14 and portions 22 can be any of a variety of shapes, including circles, squares, triangles, stars, and other geometric or non-geometric shapes, and the term “dot” and “portion” encompasses all of these shapes.

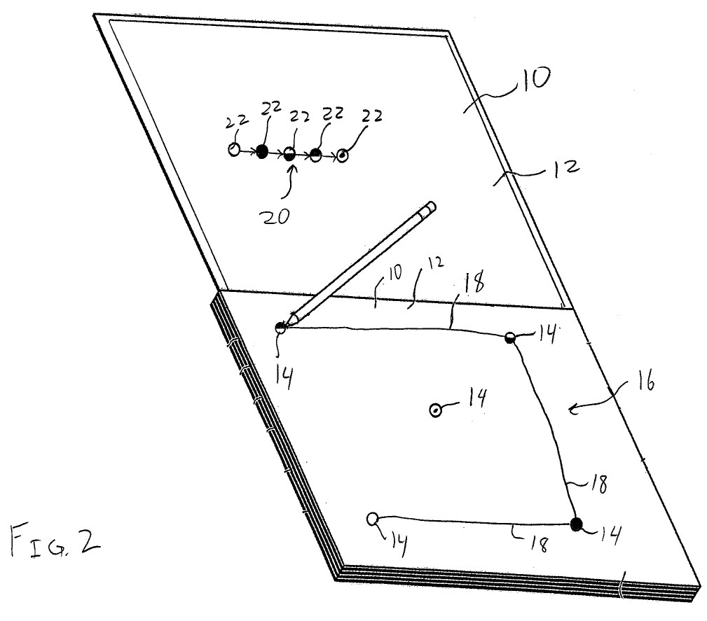

Moreover, rather than having dots 14 that differ in color, the dots 14 can differ in other optical qualities. For example, in the embodiment shown in FIG. 2, each of the dots 14 has a differing shading pattern. The sequence guide 20 instructs the users as to the proper order in which the dots 14 should be connected. This embodiment can be designed for users that are fully or partially color blind, or to develop additional pattern-recognition skills. If desired, the dots 14 can differ by various other optical qualities besides (or in addition to) color and shading, such as size, shape, combinations of these features, etc. In this case, the sequence guide 20 would include portions 22 that correspond to the optical qualities of the dots 14 to guide a user in the proper sequence of connecting the dots 14.

In the embodiment of FIG. 2, rather than being located on the same sheet as the drawing 16, the sequence guide 20 is positioned on the underside of an adjacent sheet 10. Thus, the sequence guide 20 can be located in various positions so long as the sequence guide 20 is visible to the user of the sheet 10. For example, the sequence guide 20 could be located on the cover of a bound assembly of sheets 10, on a separate sheet or guide sheet, etc.

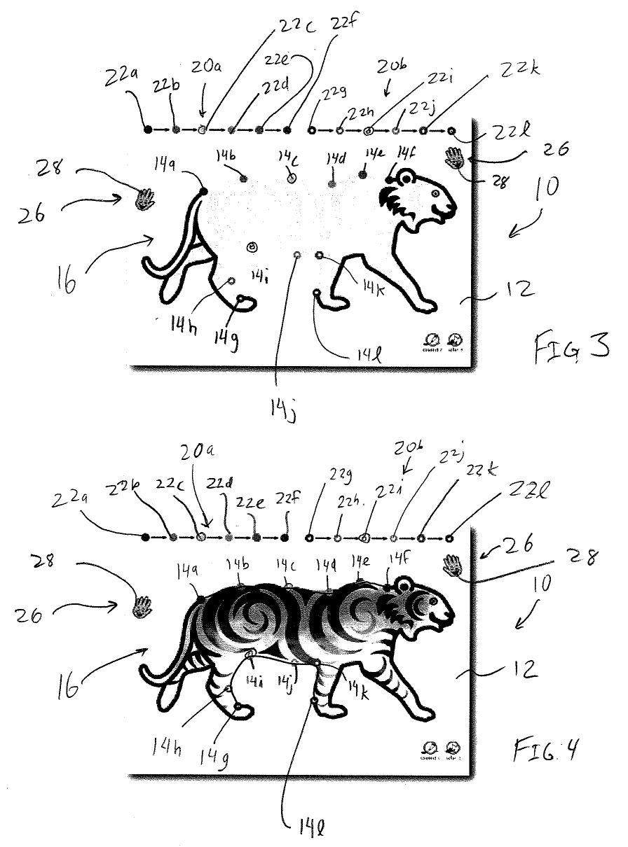

FIGS. 3 and 4 illustrate another embodiment of the invention in which the sequence guide 20 includes a first segment 20a and a second segment 20b. In the first segment 20a, the portions 22 are arranged in a sequence similar to the sequence guides of FIG. 1. That is, in one embodiment portion 22a is red, portion 22b is orange, portion 22c is yellow, portion 22d is green, portion 22e is blue and portion 22f is purple. Correspondingly, in this embodiment dot 14a is red, dot 14b is orange, dot 14c is yellow, dot 14d is green, dot 14e is blue and dot 14f is purple. In this embodiment the portions 22 are arranged in the sequence of the rainbow colors (i.e. in the ROYGBIV pattern) to aid a user in learning the rainbow color sequence, although the portions 22/dots 14 need not necessarily be arranged in this manner.

The second segment 20b includes portions 22 that are of a differing shape than the portions 22 of the first segment 20a. For example, in this embodiment, the portions 22 of the second segment 20b are hollow circles, as opposed to the complete circles of the portions 22 of the first segment 20a. However, the portions 22 of the differing segments 20a, 20b can differ by any of a wide variety of optical qualities besides shape, such as color, shading, size, combinations of these features, etc.

The optical qualities some of the dots 14 in FIG. 3 and 4 match the optical qualities of the corresponding portions 22 of the second segment 20b. Thus, for example, (hollow circle) portion 22g is red and corresponding (hollow circle) dot 22g is red; portion 22h is orange and corresponding dot 22h is orange; portion 22i is yellow and corresponding dot 22i is yellow; portion 22j is green and corresponding dot 22j is green; portion 22k is blue and corresponding dot 22k is blue; and portion 22l is purple and corresponding dot 22l is purple. Accordingly, two or more sequence guides 20 (or segments or portions thereof) can be utilized as desired to complete a drawing or shape 16, and more complex sequence guides can be presented to the user as the user develops his or her skills. Thus the use of sequence guides allow various levels of complexity to be presented to a user, as opposed to, for example, numerical or alphabetical connect-the-dot systems.

As shown in FIGS. 3 and 4, each sheet 10 may include or carry thereon at least one hand cue 26 upon which a user can place his or her hand to manually stabilize the sheet 10 during use. Each hand cue 26 may include or take the form of a visual cue 28 printed or otherwise carried on the sheet 10. In the illustrated embodiment, each visual cue 28 takes the form of a visual representation (i.e. drawing, design, photograph or the like) of a hand to cue or encourage a user to place his or her hand on the hand cue 26. However, the visual cue 28 can take the form of other indicia besides a hand. For example some other indicia (by way of example, a star, or the letter “H,” although nearly any sort of indicia can be used) may be provided on the sheet 10. A user may be taught (i.e. by the sheet 10, by associated instructions/packaging, by a teacher or parent, etc.) that the indicia 28 is to be associated with hand stabilization. In this case, when a user sees the visual cue 28 the user is prompted to stabilize the sheet 10 with his or her non-dominant (i.e. non-writing) hand.

Teachers typically have difficulty ensuring that their students properly stabilize their sheets 10 during use. Accordingly, the hand cues 26 serve as a constant reminder to the user to encourage proper stabilization and use of the sheet 10.

Each hand cue 26 may be positioned at or adjacent to the outer perimeter of the sheet 10 to ensure proper hand placement. In particular, encouraging a user to place his or her stabilization hand at or adjacent to the outer edge of the sheet 10 ensures that maximum stabilization force is exerted while ensuring that the stabilization hand does not interfere with writing operations on the sheet 10. Thus, at least part of each hand cue 26 may be located within about 3 inches of the outer edge of the sheet 10, or within about 10% or 20% of the height or width of the sheet 10 of the outer edge.

The sheet 10 may include a hand cue 26 on both the left and right sides of the sheet 10 (with the “left” and “right” orientation being taken from the perspective of a user viewing the sheet in a normal configuration as shown in FIGS. 3 and 4.) The use of two opposed hand cues 26 ensures that a hand cue 26 is sufficiently presented and available for both left-handed and right-handed users. Both hand cues 26 may be located in the upper half of the drawing sheet 12 since stabilization in the upper half of the sheet 12 is most effective and allows full access to the drawing sheet. Moreover, the hand cue 26 on the left side of the sheet 12 (utilized by right-handed users) is positioned below the hand cue 26 on the right hand side of the sheet 12 (utilized by left-handed users). Due to the layout of most drawing sheets, as well as orientation of writing desks, etc. it is desired to place the hand cue 26 for left-handed users higher on the sheet 12 than the other hand cue 26. In particular, due the differing ways in which a left-handed user typically positions and stabilizes paper compared to a right-handed user, the right cue 26 is optimally positioned higher on the sheet 10.

The arranged dots 14 in combination with the sequence guide 20 allows a user to connect the dots 14 and thereby create a drawing 16 even when the user is too young, or unable to, recognize and sequence numbers or letters. Furthermore, these features present a user with varying sequences to present new challenges as the user's skills develops. The sheet 10 may be packaged for sale along with a set of instructions that instruct a user (or a user's parents, teachers, etc.) to use the sheet 10 in the manner described herein.

The dot-to-dot sheets 10 can be used as a pre-writing activity to encourage pencil control, visual motor control, sequencing, multi-step task completion and visual closure (the ability to recognize a partially completed drawing). These skills are important for school success in many areas of learning. However, dot-to-dot sheets which utilize letter and/or number recognition and ordering requires skills that are not typically developed until the user is between four and six years old. However, color and/or shape recognition tends to develop earlier (between about two and four years old). Therefore the sheets 10 of the present invention allows users to participate in pre-writing activities even without number and letter recognition.

Having described the invention in detail and by reference to the various embodiments, it should be understood that modifications and variations thereof are possible without departing from the scope of the invention.

What is claimed is:

1. A drawing sheet assembly comprising:
a drawing sheet;
a plurality of dots printed on said sheet, said dots having a differing optical property relative to each other; and
a sequence guide configured guide a user to connect said dots in a particular sequence such that when a user connects said plurality of dots in accordance with said sequence guide a drawing or part of a drawing is created.

2. The drawing sheet assembly of claim 1 wherein said optical property is color.

3. The drawing sheet assembly of claim 2 wherein said sequence guide includes portions of differing color arranged in a sequence.

4. The drawing sheet assembly of claim 3 wherein said sequence guide includes arrows positioned between said portions of color.

5. The drawing sheet assembly of claim 3 wherein the number of said portions of color is equal to the number of said plurality of dots.

6. The drawing sheet assembly of claim 3 wherein the number of said portions of color is less than the number of said plurality of dots.

7. The drawing sheet assembly of claim 1 wherein said optical property is size or shading or shape.

8. The drawing sheet assembly of claim 7 wherein said sequence guide includes portions of differing size or shading or shape arranged in a sequence.

9. The drawing sheet assembly of claim 1 wherein each dot has a unique optical property relative to the other plurality of dots printed on said sheet.

10. The drawing sheet assembly of claim 1 wherein said drawing sheet includes an incomplete drawing printed thereon, and wherein said plurality of dots are configured such that when said plurality of dots are connected with lines in accordance with said sequence guide, said lines complete or substantially complete said drawing.

11. The drawing sheet assembly of claim 1 wherein said dots are circles.

12. The drawing sheet assembly of claim 1 wherein said sequence guide is printed on said drawing sheet.

13. The drawing sheet assembly of claim 1 wherein when a user connects said plurality of dots with lines in accordance with said sequence guide, said lines form a drawing or part of a drawing.

14. The drawing sheet assembly of claim 13 wherein said lines are straight or angled or curved.

15. The drawing sheet assembly of claim 1 wherein said drawing sheet is made from a generally water absorbent material.

16. The drawing sheet assembly of claim 1 wherein said sequence guide includes a first segment includes a plurality of portions having a common optical quality, and wherein said sequence guide includes a second segment including a plurality of portions having a common optical quality that is different from said common optical quality of said first plurality of portions.

17. The drawing sheet assembly of claim 1 wherein said drawing sheet includes a hand cue for cuing a user to place the user's hand thereon to manually stabilize said drawing sheet during use.

18. The drawing sheet assembly of claim 17 wherein said hand cue includes a representation of a hand.

19. The drawing sheet assembly of claim 17 wherein said hand cue is positioned at or adjacent to an outer perimeter of the drawing sheet.

20. The drawing sheet assembly of claim 17 further comprising a supplemental hand cue on said drawing sheet, and wherein said drawing sheet has printing thereon that is designed to be read when said drawing sheet is in a particular orientation, and wherein said hand cue is located adjacent to a left edge and said supplemental hand cue is located adjacent to a right edge when said drawing sheet is in said particular orientation.

21. A method for using a drawing sheet comprising:
providing a drawing sheet having a plurality of dots on said sheet, said dots having a differing optical property relative to each other;
providing a sequence guide; and
encouraging a user to connect said dots in a particular sequence as taught by said sequence guide such that when a user connects said plurality of dots in the prescribed manner a drawing or part of a drawing is created.

22. The method of claim 21 wherein said optical property is at least one of color or size or shading or shape.

23. The method of claim 22 wherein said sequence guide includes portions of differing color or size or shading or shape arranged in a sequence.

24. The method of claim 21 further comprising the step of a user connecting said plurality of dots with lines in accordance with said sequence guide such that said lines form a drawing or part of a drawing.
